(19) United States
(12) Patent Application Publication
(10) Pub. No.: US 2016/0055462 A1
(43) Pub. Date: Feb. 25, 2016

(54) BRAND-SPONSORED CUSTOMER PAYMENT CARD

(71) Applicant: Aintu Inc., San Jose, CA (US)

(72) Inventor: Arthur Vaysman, San Jose, CA (US)

(21) Appl. No.: 14/834,400

(22) Filed: Aug. 24, 2015

Related U.S. Application Data
(60) Provisional application No. 62/040,982, filed on Aug. 22, 2014.

(51) Int. Cl. G06Q 20/10; G06Q 20/02; G06Q 20/40

(52) U.S. Cl. CPC G06Q 20/10; G06Q 20/409; G06Q 20/02

(57) ABSTRACT

A method to operating a deposit account for a customer is provided. The method comprises maintaining a deposit account for a customer on a third party server, said deposit account comprising a customer deposits component, and a brand deposits component, wherein the customer deposits component comprises cash received from the customer, and the brand deposits component comprises brand deposits received from at least one brand owner; enabling the customer to make a payment request to at least partially pay for an item with funds from the deposit account during a check out process at a retailer; enabling said retailer to initiate a payment authorization request to the third party server in respect of the payment request; processing the payment authorization request by the third party server, comprising generating a payment authorization response to said retailer; wherein said payment authorization response includes an authorization message selectively generated to authorize the retailer to accept payment via the deposit account.

This application claims the benefit of priority to U.S. Provisional Patent Application No. 62/040,982 entitled “LOYALTY PROGRAM FOR BRANDS”, which was filed on Aug. 22, 2014, the entire specification of which is incorporated herein by reference.

### FIELD

Embodiments of the invention relate to payment cards.

### BACKGROUND

The term “unbanked” refers to a sector of the population that that do not have bank accounts or access to financial institutions. It is estimated that about three quarters world's population are unbanked. This problem is particularly acute, in developing countries not only because of poverty, but the cost, travel distance and amount of paperwork involved in opening a bank account.

### SUMMARY

Embodiments of the present invention, disclose techniques and systems to bring payment cards to the unbanked.

A computer-implemented method is provided. The method comprises: maintaining a deposit account for a customer on a third party server, said deposit account comprising a customer deposits component, and a brand deposits component, wherein the customer deposits component comprises cash received from the customer, and the brand deposits component comprises brand deposits received from at least one brand owner, enabling the customer to make a payment request to at least partially pay for an item with funds from the deposit account during a check out process at a retailer; enabling said retailer to initiate a payment authorization request to the third party server in respect of the payment request; and processing the payment authorization request by the third party server, comprising generating a payment authorization response to said retailer; wherein said payment authorization response includes an authorization message selectively generated to authorize the retailer to accept payment via the deposit account.

Other aspects of the invention will be apparent from the detailed description that follows.

### BRIEF DESCRIPTION OF THE DRAWINGS

FIG. 1 shows a deployment drawing in accordance with one embodiment of the invention

FIG. 2 shows the use cases for the DCPMS, in accordance with one embodiment of the invention.

FIG. 3 shows the use cases for coupon generation, in accordance with one embodiment of the invention.

FIG. 4 shows the use cases for coupon clipping and publishing in accordance with one embodiment of the invention.

FIG. 5 shows a coupon query Q1, in accordance with one embodiment of the invention.

FIG. 6 shows the use cases for the customer coupon app, in accordance with one embodiment of the invention.

FIGS. 7a-b shows a Publisher publishing media on a Customer node, in accordance with one embodiment of the invention.

FIG. 8 shows a flowchart for processing a coupon clipping notification, in accordance with one embodiment of the invention.

FIG. 9A shows the use cases for coupon redemption by the customer coupon app, in accordance with one embodiment of the invention.

FIG. 9B shows the use cases for coupon redemption by the retailer coupon app, in accordance with one embodiment of the invention.

FIG. 10 shows an example of published coupon, in accordance with one embodiment of the invention.

FIG. 11 shows the published coupon of FIG. 10 in magnified view, in accordance with one embodiment of the invention.

FIG. 12 shows an example of a report to an Advertiser, in accordance with one embodiment of the invention.

FIG. 13-15 illustrate how would deposit account may be credited, in accordance with one embodiment of the invention.

FIG. 16 illustrates an example of an interface 1600 of the coupon app to assist the consumer in making payment using the consumers deposit account, in accordance with one embodiment of the invention

FIG. 17 shows the processing steps executed by the coupon system in order to service a payment authorization request message, and cons in one embodiment of the invention.

FIG. 18 illustrates the structure of a customer deposit account, in accordance with one embodiment of the invention.

FIG. 19 shows an example of a data structure that may be used to facilitate the proper use of brand deposits, in accordance with one embodiment of the invention.

FIG. 20 and this is a structure of the payment authorization request, in accordance with one embodiment of the invention.

FIG. 21 shows a high-level block diagram of hardware for implementing the DCPMS, in accordance with one embodiment of the invention.

### DETAILED DESCRIPTION OF SOME EMBODIMENTS

In the following description, for purposes of explanation, numerous specific details are set forth in order to provide a thorough understanding of the invention. It will be apparent, however, to one skilled in the art that the invention can be practiced without these specific details. In other instances, structures and devices are shown in block diagram form only in order to avoid obscuring the invention.

Reference in this specification to “one embodiment” or “an embodiment” means that a particular feature, structure, or characteristic described in connection with the embodiment is included in at least one embodiment of the invention. The appearance of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

Moreover, although the following description contains many specifics for the purposes of illustration, anyone skilled in the art will appreciate that many variations and/or alterations to said details are within the scope of the present invention. Similarly, although many of the features of the present invention are described in terms of each other, or in conjunction with each other, one skilled in the art will appreciate that many of these features can be provided independently of other features. Accordingly, this description of the invention is set forth without any loss of generality to, and without imposing limitations upon, the invention.

Embodiments of the present invention facilitate the placement of a coupon within an advertisement.

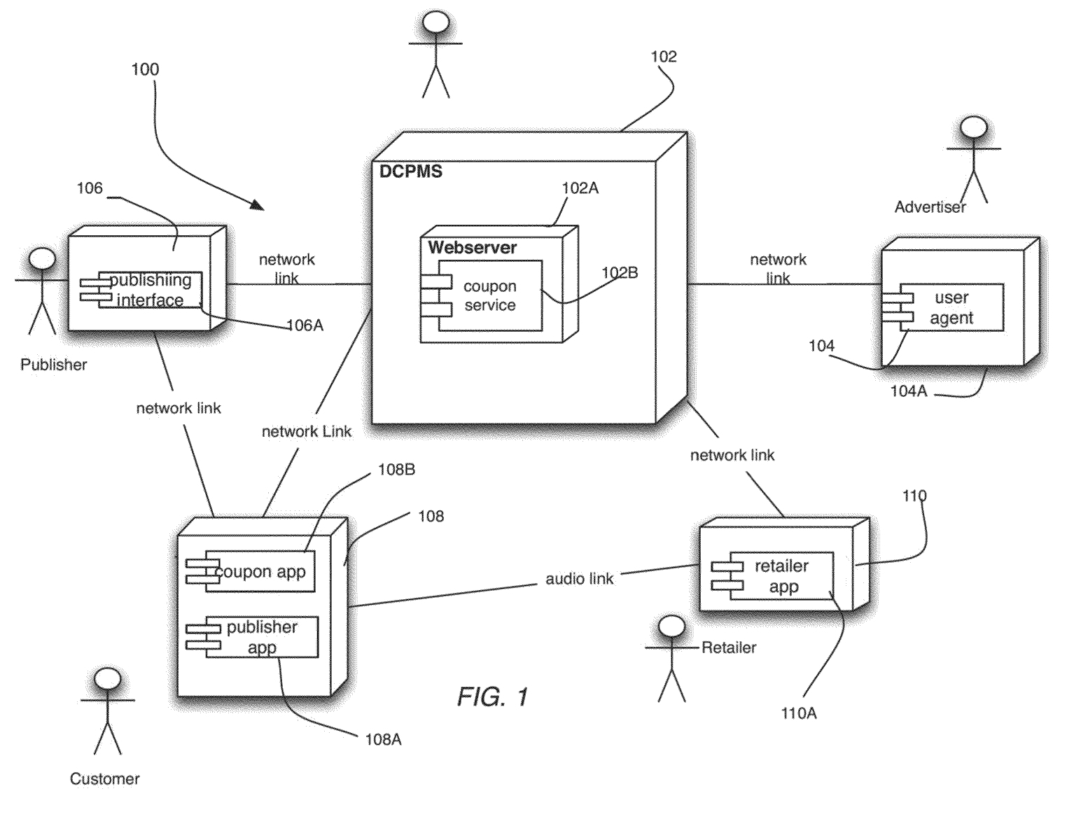

FIG. 1 shows a deployment scenario 100 in accordance with one embodiment of the invention. Referring to FIG. 1 a Digital Coupon Personalization and Management System (DCPMS) 102 includes a server component 102A which implements a Coupon Service (CS) 102B. The CS 102B is under control of a Coupon Service Provider (CSP) A plurality of advertiser nodes 104 each equipped with an appropriate user agent (browser) 104A are communicatively coupled to the DCPMS 102 by means of a network link 112. In one embodiment, each advertiser node 104 may include a computing device such as a laptop or PC, and the network link 112 may comprise the Internet. Each advertiser node 104 represent an Advertiser who uses the CS to generate coupons on its behalf, as will be explained.

The DCPMS 102 may also be communicatively coupled with plurality of publisher nodes 106 by means of a network link 112. Each publisher node 106 represents a computing device such as a PC and includes a publishing interface 106A, which represent the mechanism whereby a Publisher is able to publish media on a customer node 108 for viewing by a Customer. Examples of Publishers includes CNN, Facebook, YouTube, etc.

The customer node 108 represents a customer device such as smartphone or tablet PC. In one embodiment, the customer node 108 may include a publisher app 108A and a coupon app 108B. The publisher app 108A may be configured to receive media content from a Publisher, as will be described more fully later. The media content may include a personalized coupon generated by the DCPMS 102.

Finally, the deployment scenario 100 also includes a retailer node 110 which represents retailer. In one embodiment, the customer node 108 communicates with the retailer node 110 via an audio link 114.

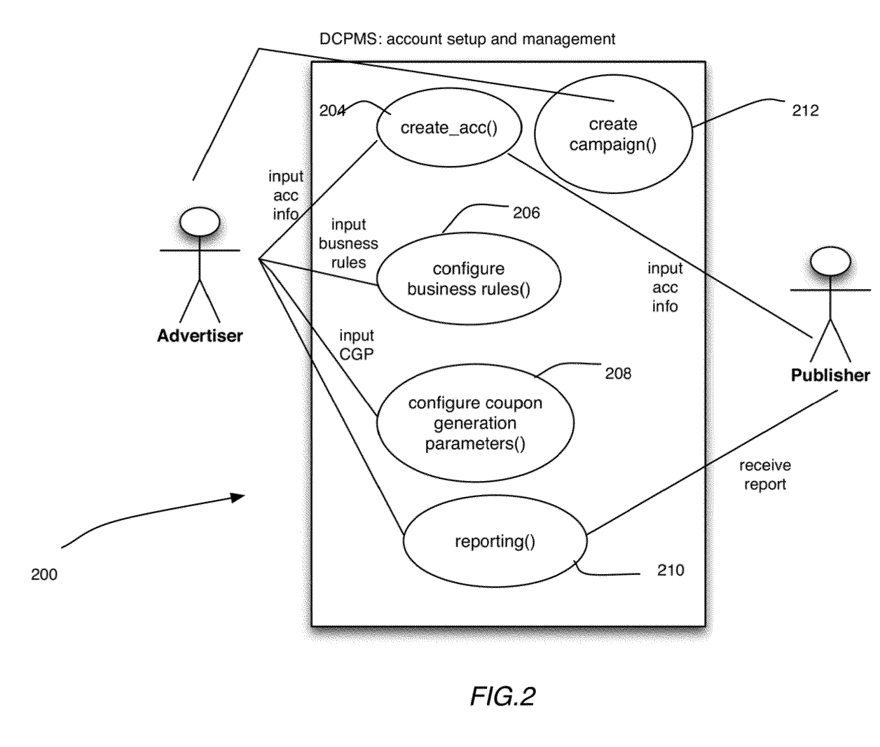

FIG. 2 shows use cases 200 for the DCPMS 102, in accordance with one embodiment of the invention. As will be seen, the DCPMS 102 supports a create_account ( ) function 202 which allows an Advertiser and a Publisher to create user accounts on the DCPMS 102. A configure_business_rules ( ) function 208 allows an Advertiser to provision business rules and objectives in the DCPMS 102. The business rules and objectives may be used to generate highly personalized coupons for publishing to particular customers, as will be described. The use cases 200 also includes a configure_coupon_generation_parameters( ) process 210 whereby an advertiser configures coupon generation parameters which are used to generate personalized coupons. Examples of coupon generation parameters include the following:
(a) Demographic data;
(b) Geographic data;
(c) Offer size for a coupon offer. This may be specified in the terms of a minimum offer size and a maximum offer size;
(d) The particular medium for which a coupon needs to be generated. Examples of media include video content, banner ads, and printed ads.
(e) Publisher. Examples of publishers includes Facebook, YouTube, CNN etc.;
(f) Context for the coupon. Examples of contexts includes sports, politics, science, business, lifestyle, etc.;
(g) Psycho-graphic information comprising values, opinions, attributes, interests, and lifestyles associated with a target demographic group.

Finally, the use cases 200 include a reporting ( ) function 212 whereby reports are generated for Advertisers and Publishers.

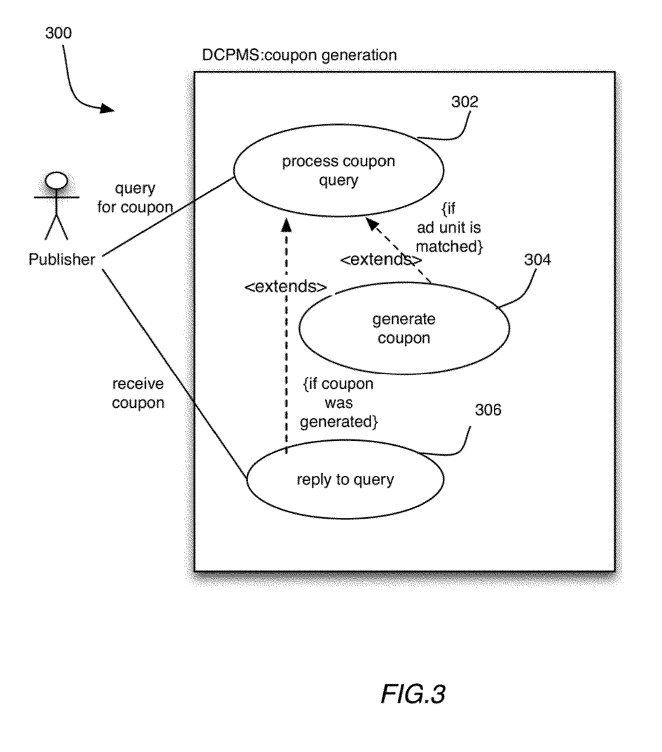

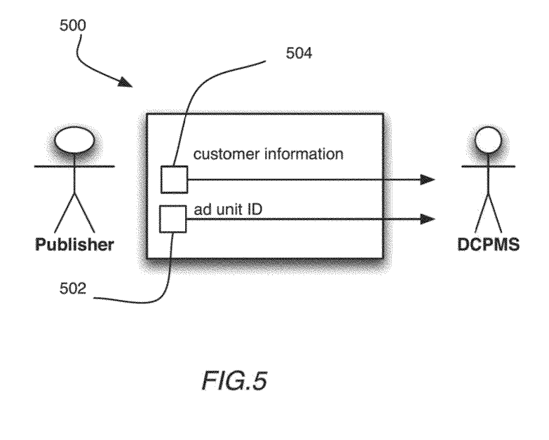

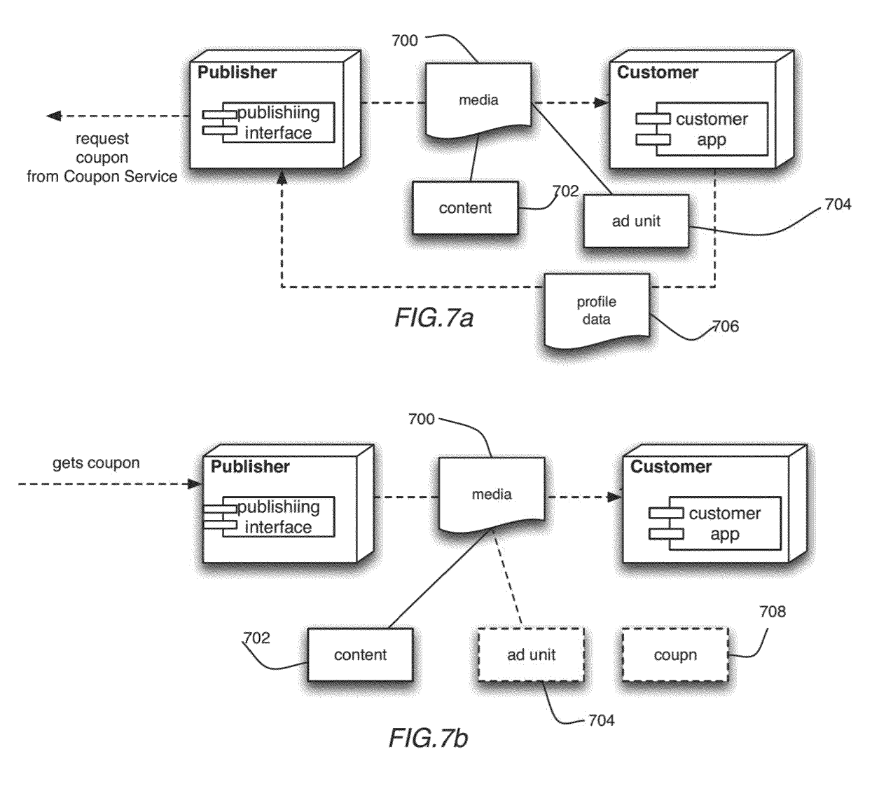

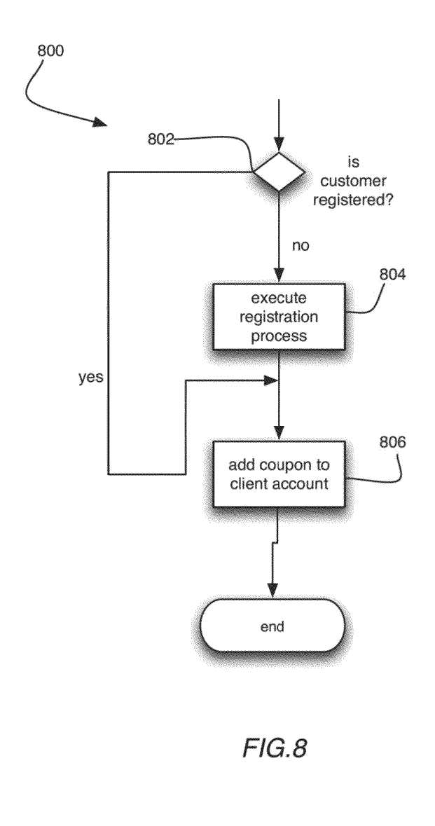

Referring now to FIG. 3 of the drawings, there is shown use cases 300 for coupon generation, in accordance with one embodiment of the invention. In terms of the use cases 300, a Publisher sends a query Q1 to the DCPMS 102. The query Q1 is a request for a coupon. Generally, at the time of sending the query Q1, the Publisher is already publishing content to a customer and is the further, typically displaying an advertisement unit (ad unit) in association with the content. This can be seen in FIG. 7a, which shows media 700 being published on a customer node 108, wherein the media 700 includes content 702 and an ad unit 704. FIG. 5 shows the elements of the query Q1, in one embodiment. As will be seen, Q1 includes customer information 500 and an ad unit id 502. The ad unit id 502 corresponds to the ad unit being shown to the Customer. The customer information corresponds to profile information/data 706 (see FIG. 8) about the Customer. The profile data 706 is collected from the Customer node 108 by the Publisher and includes that customer's browsing behavior and information about the customer device itself.

Responsive to receiving the coupon query Q1, the DCPMS 102 executes a process coupon query block 304. Under this block, the DCPMS 102 attempts to match the ad unit id in the coupon query Q1 in an ad unit list. The ad unit list is provisioned by an Advertiser and is basically a listing of ad units for which coupons must be generated by DCPMS 102. Thus, under the process 304, if the ad unit id is matched then a generate coupon function 306 is executed. Under this process, a personalized coupon is generated based on the coupon configuration parameters and based on machine learning techniques.

The use cases 300 also include a reply to query function 308 wherein the DCPMS 102 replies to the query Q1 by returning a coupon to the publisher 302 or a reply indicating that no coupon is available for the particular ad unit associated with the coupon request Q1. FIG. 7B shows the media 700 that is published on a customer node 108 as updated by the Publisher to include a coupon 708.

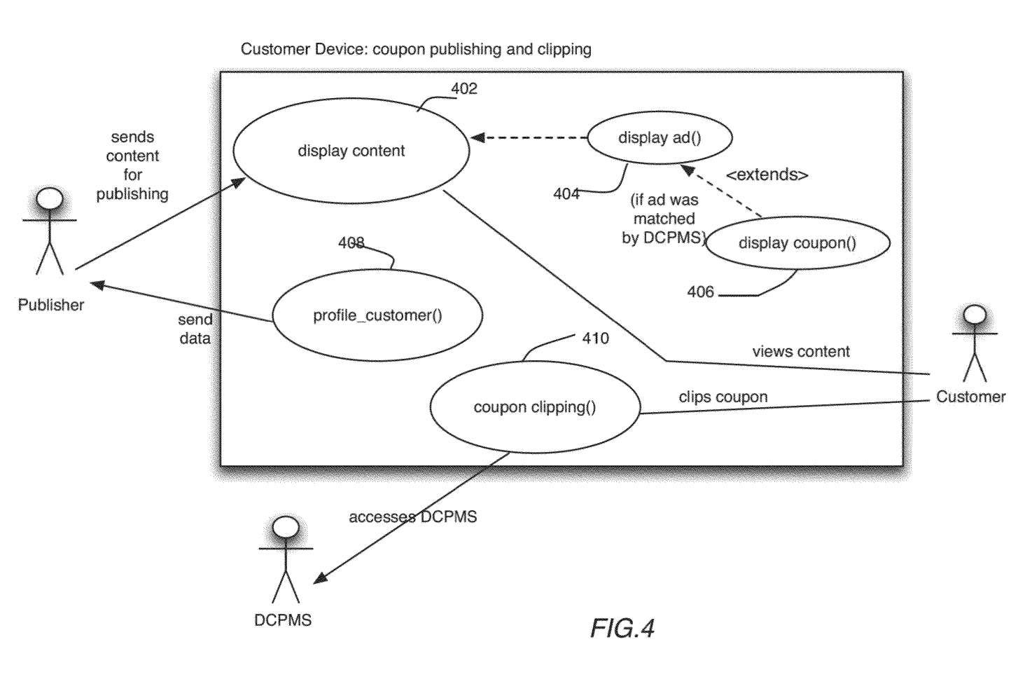

FIG. 4 shows use cases 400 for coupon displaying and clipping on the customer node 402, in accordance with one embodiment of the invention. As will be seen, the customer node 108 is configured to display content by executing a display content function 402. The display content function 402 may be extended to include a display ad function 404 which in turn may be extended to include a display coupon function 406 if the ad unit associated with the ad being displayed is match by the DCPMS 102, as described earlier. A profile customer ( ) function 408 collects profile information for a customer which is transmitted to the Publisher. The use cases 400 also includes a coupon clipping ( ) function 410. Under the coupon clipping function 410, a Customer performs a ‘clipping action’ in relation to a coupon. For example, in one embodiment, the clipping action may include selection of a clipping button associated with the coupon. Responsive to said clipping action, the coupon clipping function 410 generates a coupon clipping notification and transmits it to the DCPMS 102.

Referring now to FIG. 8 of the drawings, there is shown a process 800 executed on the DCPMS 102 responsive to receiving a coupon clipping notification. At block 802, a check is made to determine if the customer is a registered customer. In one embodiment this step includes validating customer credentials included in the coupon clipping notification. If it is determined that the customer was not registered, then at block 804, a registration process is executed in order to register the customer. This process may include redirecting a customer to a registration page in order for the customer to input registration information. In one embodiment, the registration information may comprise the name of the customer, and their customer's address. As part of the registration process, each customer is assigned a unique customer ID to identify the customer within the system. At block 806, the coupon identified by the coupon id in the coupon clipping notification is added to the customer's account. At this point, the DCPMS 102 may inform the Publisher that the coupon has been clipped, in which case the publisher may instruct a browser being used by the customer node 108 to view the coupon to stop displaying the coupon.

In the case where a Customer is using the coupon app 108B to view the published content, the coupon app 108B includes logic to stop showing the coupon as soon as the coupon clipping action is performed. Thus, a seamless coupon clipping experience is facilitated.

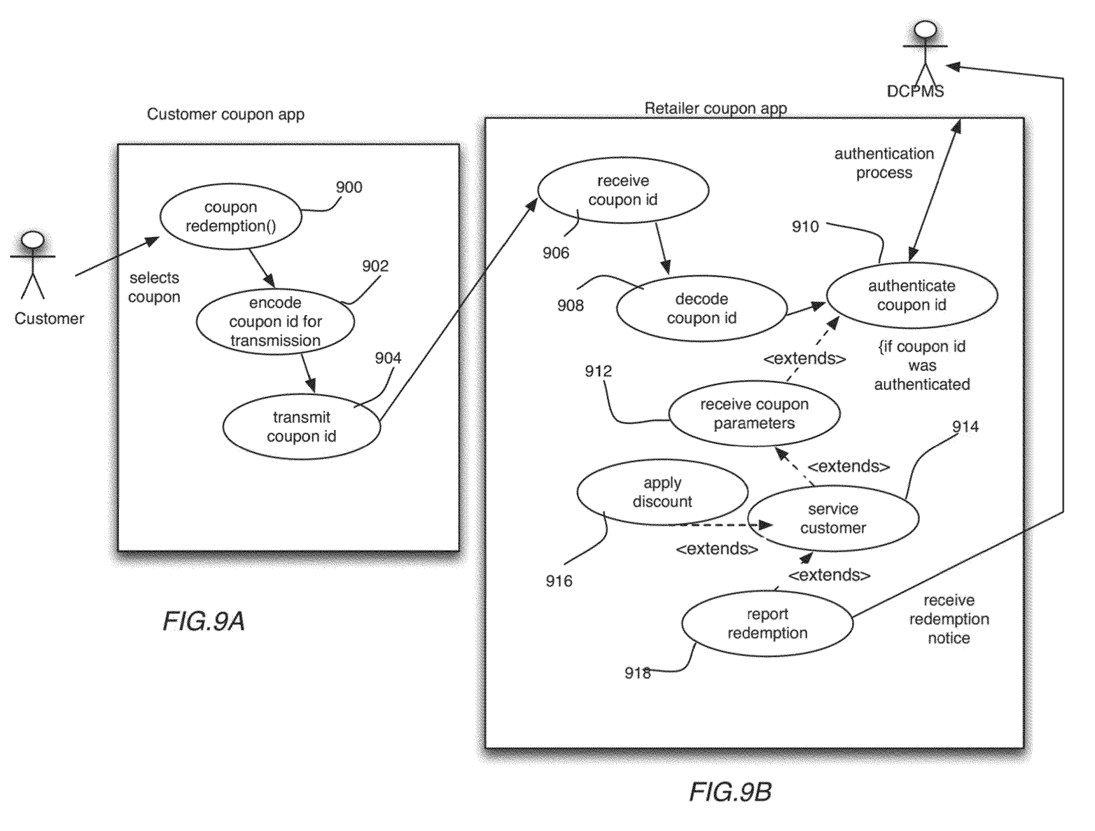

Referring now to FIG. 9A of the drawings, there is shown a use case for coupon redemption by a Customer. As will be seen, a coupon redemption( ) function 900 includes a process 902 for encoding a coupon for transmission, and a process 904 for transmitting said encoded coupon to a retailer node. In one embodiment, the process 902 for encoding the coupon for transmission encodes the coupon as an audio signal which is then transmitted via a speaker associated with the customer node 108. The retailer node 110 then uses a microphone to detect the audio encoding. FIG. 9B also shows a use case for the retailer coupon app 110A to redeem a coupon, in accordance with one embodiment. Referring to FIG. 9B, process 906 comprises a receive coupon id ( ) function whereby a microphone of the retailer node 110 is used to listen for the coupon transmission from the customer node 108. A decode coupon id ( ) process 908 decodes the audio signal in order to extract the coupon id. An authenticate coupon id ( ) process 910 includes transmission of the coupon id to the DCPMS 102 by the retailer coupon app for authentication. The DCPMS 102 authenticates the coupon id and returns coupon parameters associated with the coupon id that was authenticated. The retailer coupon app then executes a receive coupon parameter( ) function 912 to receive the coupon parameters from the DCPMS 102. A service customer ( ) function 914 includes servicing the customer by providing the goods and/or services associated with the coupon. A apply discount ( ) function 916 extends the service customer ( ) function 914 to apply the discount indicated in the coupon to the transaction with the customer. A report redemption ( ) function 918 includes operations to report any coupon redemption to the DCPMS 102.

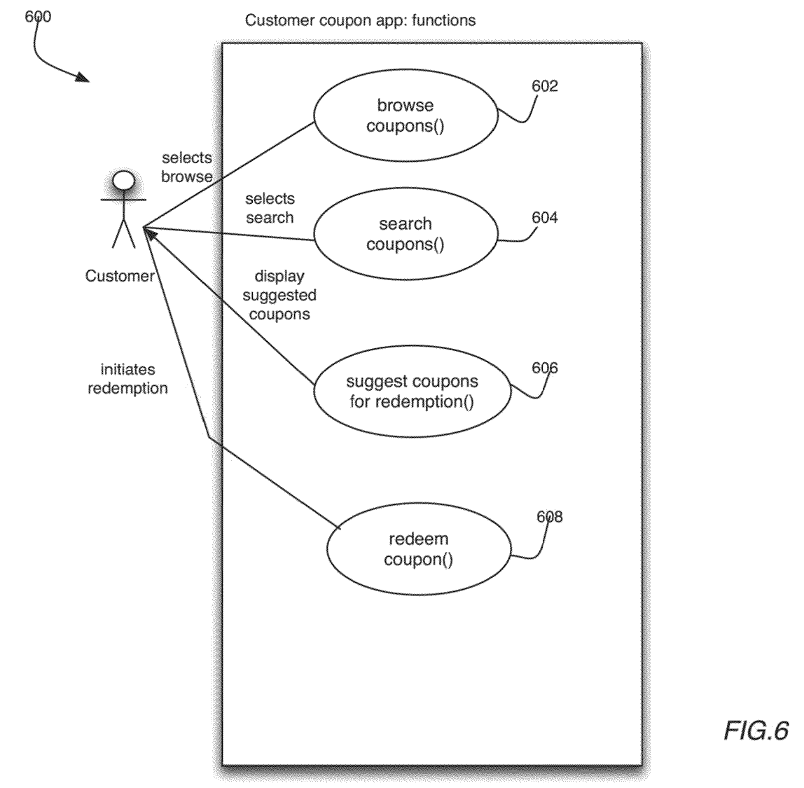

Referring now to FIG. 6 of the drawings, use cases 600 are associated with the coupon app 108B. As will be seen, the use cases 600 may include a browse coupons ( ) function 602. This function allows a Customer to browse previously clipped coupons. A search coupon ( ) function 604 allows the Customer to search for particular coupons based on search criteria. A suggest coupon for redemption ( ) function 608 implements functionality to proactively suggest coupons for redemption to a Customer. For example, in one embodiment based on the location, the Customer may be shown coupons that are only available for redemption at that particular location. Finally, the use case 600 includes a redeem coupon function ( ) 610, whereby the Customer may redeem a selected coupon, as has been described above.

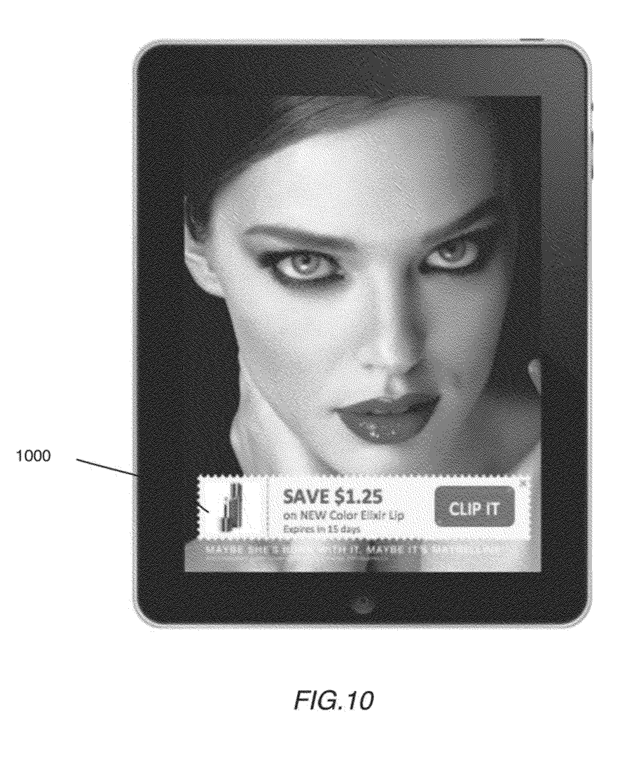

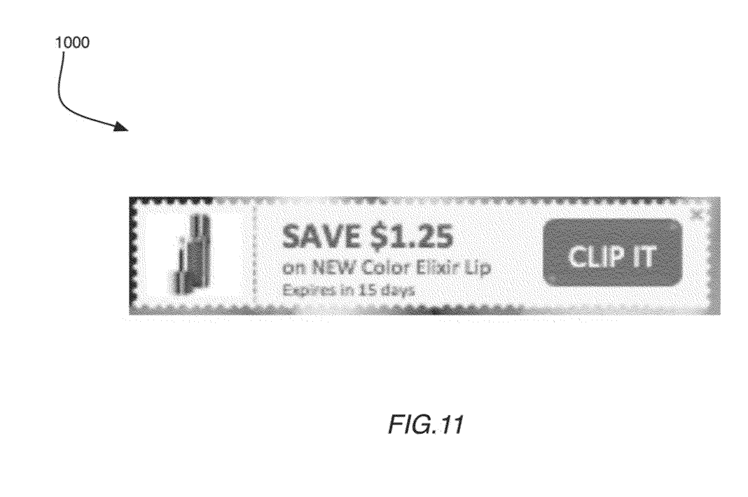

Referring now to FIG. 10 of the drawings, there is shown a coupon 1000 which is published in association with an advertisement for women's lipstick. The coupon 1000 is shown in magnified view FIG. 11 of the drawings. As will be seen, the coupon 1000 includes a discount of $1.25, and a coupon expiration, which is set to 15 days. Further, the coupon 1000 includes a ‘clip it button’. This button may be used to clip the coupon 1000 in accordance with the techniques disclosed herein.

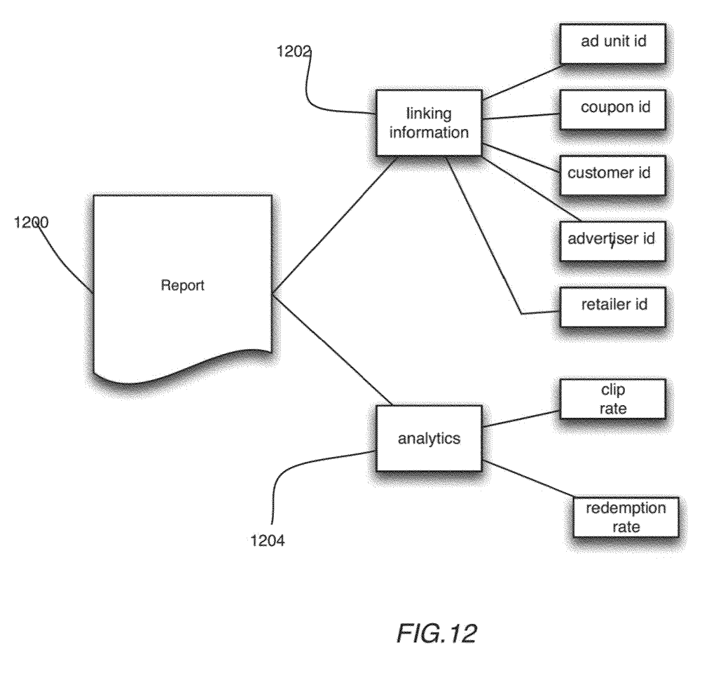

FIG. 12 shows a report 1200 that may be generated for an Advertiser, in accordance with one embodiment. The report 1200 includes linking information 1202 to link ad unit id, coupon id, customer ID, advertiser id, and retailer id. Report 1200 also includes an analytics component 1204 which may provide detailed analysis on a coupon's clip rate and its redemption rate. The coupon clip rate and redemption rate may be used to optimize a coupon campaign. As has been mentioned, machine running techniques are used to generate a coupon in a dynamic fashion. For example, coupon may be configured to have a certain clip rate and a certain redemption. If a clip rate for a coupon is too high the system may dynamically reduce the discount associated with the coupon in order to throttle or scale back the redemption rate. Alternatively, if the coupon clip rate is too low, then the DCPM 102 may dynamically increase the discount associated with the coupon in order to achieve the desired clip rate. Likewise, a coupons redemptions rate may be used to dynamically scale the offer sized associated with the coupon in order to achieve a desirable redemption rate.

### Loyalty Program for Brands

In one embodiment, the technology disclosed herein may be used to operate a loyalty program for brands such as Coca-Cola, Unilever, P&G, etc. For this embodiment, the Coupon Service (CS) collects coupon redemption information for each customer whenever the customer redeems a coupon at a retailer node 100. The coupon redemption information for each customer may be collected across various retailer nodes 110, such as Target, Walmart, Safeway, etc. The coupon redemption information may be analyzed by the CS in order identify loyal customers of particular brands. This information may be shared with brand owners to give them an opportunity to reward loyal customers. Examples of rewards may include ad hoc or random coupons generated for loyal customers who meet certain criteria. The random coupons may be then pushed to the coupon apps 108A of those customers who meet said criteria. Examples of criteria include a certain volume of purchases of a particular item over a certain period, or purchased of other brands of the same brand owner by the same customer, etc. In one embodiment, a brand loyalty program may be initiated based on a clipped coupon which was clipped in the manner described by a customer so that the clipped coupon is available in the customer's coupon app 108B. In this embodiment, each time the clipped coupon is redeemed, the CS may recharge the coupon by making it available for subsequent redemptions. Based on rules provisioned for the CS, each recharging of a coupon after its redemption may have the same discount as an earlier version of the coupon or it may have a deeper discount which may be determined based on a threshold number of redemptions. Thus, progressive discounting may be achieved based on purchasing volume over time.

In some cases, a coupons face value may be overridden to a deeper discount in real time, if a customer is attempting to redeem the coupon based on a high volume purchase. For this case, the authenticate coupon id ( ) process 910 may includes transmission of the coupon id to the DCPMS 102 by the retailer coupon app for authentication as before and additionally, the number of items being purchased. The number of items being purchased allows the DCPMS 102 to dynamically modify the discount associated with a coupon based on the number of items being purchased.

In cases where shopping is not facilitated by a POS system, the above-described loyalty program for brands is particularly useful.

In one variation of a brand loyalty program, coupons clipped to the consumer app may include a series of coupons that together form a coupon set or “booklet”. As the consumer redeems the coupons in the booklet over time, the DCPMS may be configured to offer progressively deeper discounts to the later-used coupons in the booklet as a reward for brand loyalty.

### Payment Card Functionality

In one embodiment, the technology described herein may be used by a brand owner to operate a payment card. For example, for each loyal customer, a brand owner may maintain a deposit account. This account may accumulate cash deposits over time. In some cases, the cash deposits may be made by customers directly into their deposit accounts. This may be achieved by direct deposit at a bank or at a retailer. In the case of a bank, the customer will make a payment into an account of the brand owner and will identify himself/herself with a unique id that can be used by the brand owner to allocate the deposit to the correct customer. In one embodiment, the unique ID may be the same as the customer ID used for coupon redemptions. In the case of deposit at a retailer, the retailer receives the money and engages in a clearing operation to move the money to a brand owner who then allocates it to the correct deposit account based on the unique id. In other cases, a deposit account may be charged when the brand owner makes a deposit into it. The latter may occur to reward brand loyalty. Thus, for example, based on past coupon redemption information associated with a customer, the brand owner may decide to make a deposit of a monetary amount into the deposit account of the customer.

Once a deposit account has money in it, said money may be used to pay for goods and services of the brand owner. Thus, when a customer uses the coupon app to redeem a coupon, the deposit account of the customer may be checked. This may be achieved by The DCPMS 102 based on information provisioned therein by a brand owner, or it may be achieved by an API call to a system of the brand owner. For deposit accounts with positive balances, customers may be allowed to apply all or a portion of the funds in their deposit accounts as payment for the goods and services. Thus, the loyalty program payment card may be operated as a debit card for the brand owner.

In one embodiment, instead of depositing money into a deposit account, a brand owner may deposit points into the account. The points may then we used as a form of payment for goods and services.

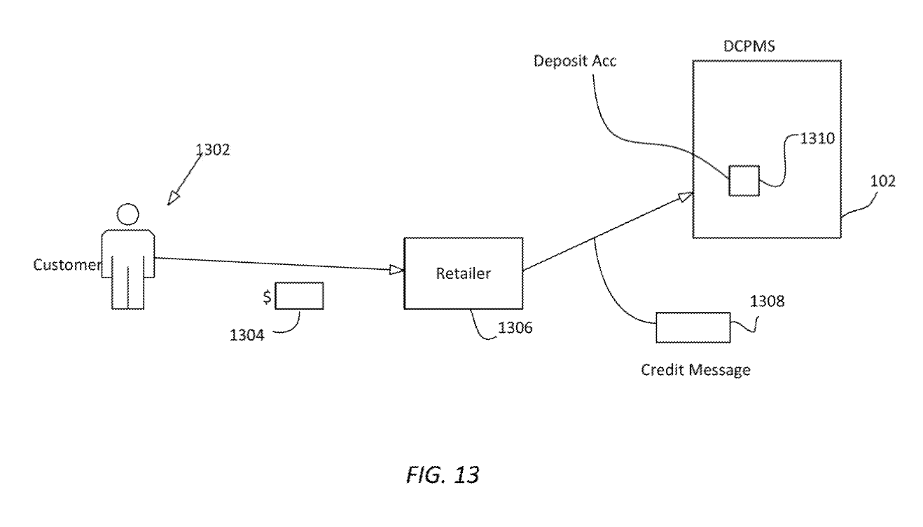

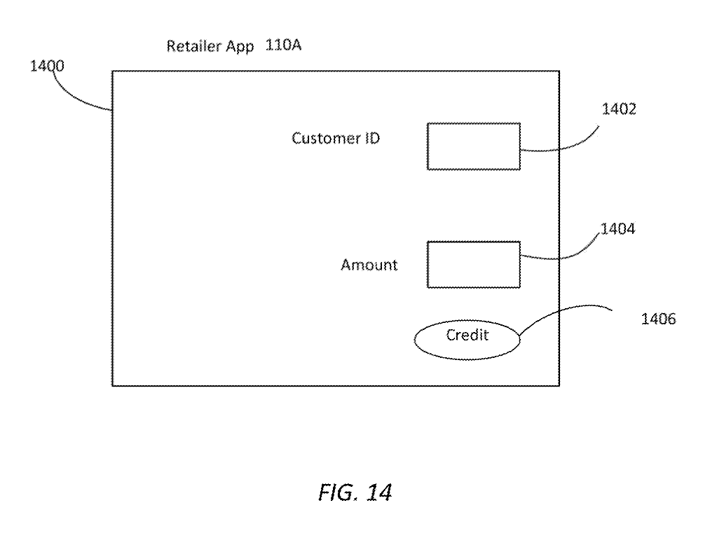

FIGS. 13 to 15 illustrate how the deposit account may be credited with an amount, in accordance with one embodiment. Referring to FIG. 13, a customer 1302 makes a deposit 1304 at a retailer 1306. For the sake of illustration, assume that the deposit 1304 comprises $50.00. To make the deposit 1304, the customer 1302 physically hands over $50.00 to the retailer 1306 and instructs the retailer to credit his/her deposit account 1310 with a $50.00. The customer 1302 identifies the deposit account by his/her own unique customer ID assigned under the couponing service. In response, the retailer 1306 receives the $50.00 and credits the customer's deposit account with that amount. For this purpose, that retailer app 110A may include an interface to facilitate this process. For example, as shown in FIG. 14, the retailer app 110A may include the interface 1400 to capture the customer ID 1402 and the amount 1404 of the deposit. A credit button 1406, executes a process to credit the customer's deposit account with the amount of the deposit. This process includes transmitting a credit message 1308 to the DCPMS 102. The credit message may include the customer ID, and the amount of the deposit.

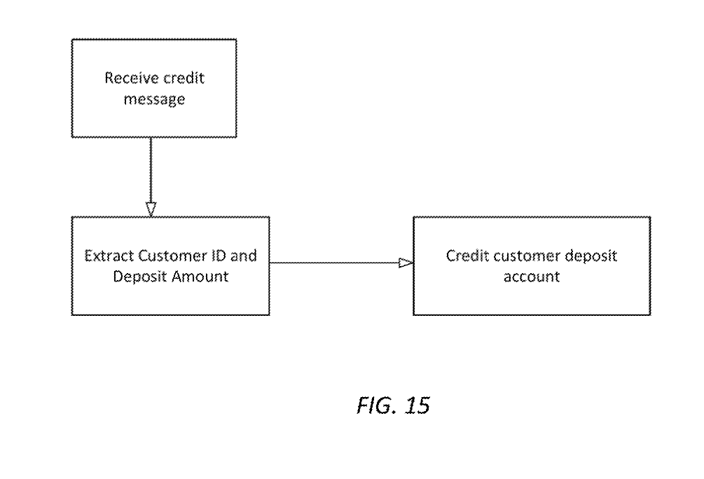

Referring now to FIG. 15 of the drawings, the steps performed by the DCPMS 102 in order to credit a customer's deposit account, in accordance with one embodiment, are shown. As will be seen at block 1500, the DCPMS 102 receives the credit message. As described, the credit message originates from the retailer. However, in other embodiments, the credit message may originate from a brand owner, for example, in cases where said brand owner wishes to reward a customer with cash for loyalty to a particular brand. At block 1502, the DCPMS 102 extracts the customer ID and the amount of the deposit from the credit message. At block 1504, the DCPMS 102 then credits that customer's deposit account with the amount of the deposit. Thus, in the present example, the deposit up account maintained for the customer 1302 will be credited with

The consumer 1302 may use his/her deposit account to make a purchase at a retailer. As per normal, the customer 1302 picks an item to purchase and proceeds to the checkout counter. At the checkout counter, the customer 1302 activates the coupon app 108B and transmits any coupon associated with the item being purchased to the retailer app 110A, in the manner already described. However, the coupon app 108B may additionally be provisioned with a user interface to allow the customer to pay at least a portion of the purchase price of the item using funds in the customer's deposit account. For example, the coupon app 108B may be configured to, upon recognizing that the item being purchased, is from a brand owner with whom the customer maintains a deposit account, prompt the user to make payment for the item using the funds in the deposit account. The aforementioned recognition of the item been purchased the as being from the brand owner may be facilitated by the consumer when consumer scans the item being purchased using the coupon app 108B.

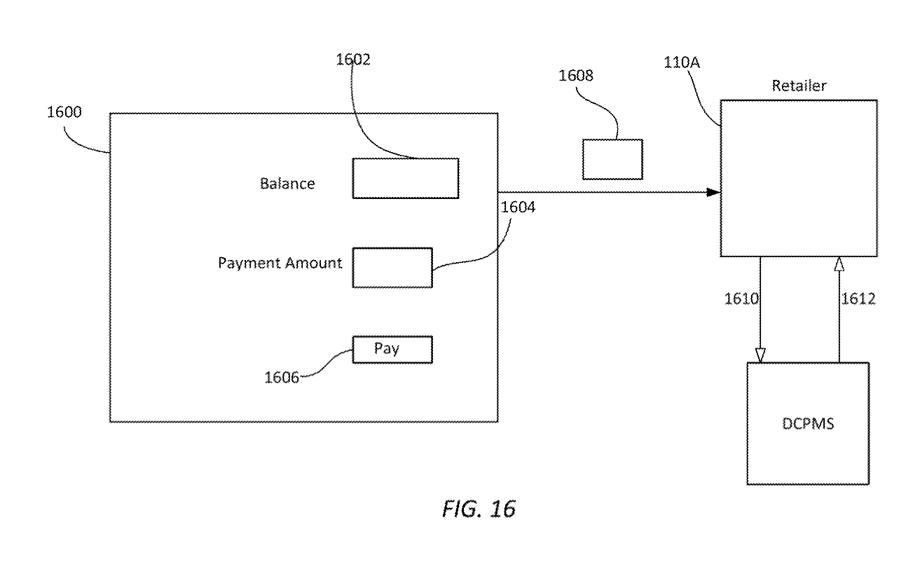

FIG. 16 illustrates an example of an interface 1600 of the coupon app to assist the consumer in making payment using the consumer's deposit account. As will be seen, the interface 1600 displays the balance 1602 of the customer's deposit account. An input area 1604 allows the customer to input the amount of money from the deposit account that the customer wishes to use in order to pay for the item. The interface 1600 also includes a pay button 1606. When the pay button 1606 is selected, the coupon app 108B creates a payment message. In one embodiment, the payment message identifies the customer by the customer's customer ID, and includes the amount being paid by means of the customs deposit account. The payment message may be transmitted to the retailer (more particularly the retailer app 110A of the retailer), as indicated by reference 1608. The payment message may be transmitted to the retailer app 110A by means of the microphone associated with the customer's mobile device, in accordance with the techniques already described. In response, the retailer app 110A receives the payment message and decodes it to extract the customer ID, and the amount of payment from the deposit account. In some embodiments, the retailer app 110A may be configured to process the payment message by sending a payment authorization request message to the DCPMS 102. The payment authorization request message 1610 may include the customer ID, and the payment amount.

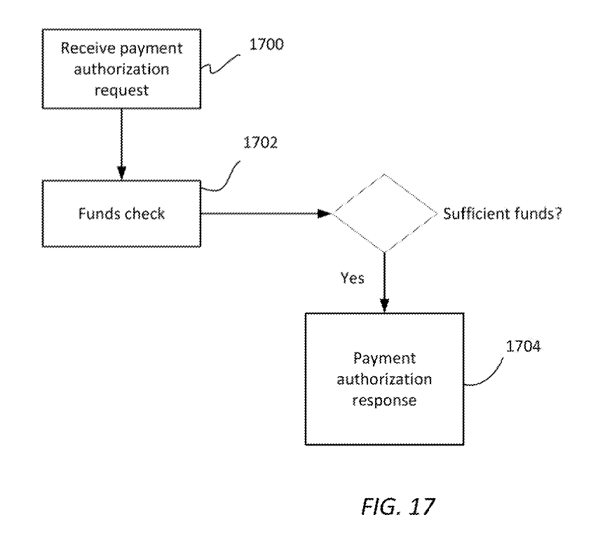

FIG. 17 shows processing steps executed by the DCPMS 102, in accordance with one embodiment, in order to service the payment authorization request message. Referring to FIG. 17, at block 1700, the DCPMS 102 receives the payment authorization request message from the retailer. The payment authorization request message is decoded to extract the customer ID, and the amount of the payment from the customers deposit account. At block 1702, and funds check process is executed in terms of which the customer's deposit account is checked in order to determine if there is sufficient funds to cover the requested payment amount. If there is sufficient funds, then at block 1704, an authorization response message is composed and transmitted to the retailer indicating that payment is authorized. If they are insufficient funds, then an authorization response message is composed and transmitted to the retailer with an indication that the payment is not authorized. For payments that authorized, the retailer supplies the item being purchased to the consumer. In one embodiment, in order to confirm the transaction, the retailer app 110A may be configured to send a payment confirmation message to the DCPMS 102. For example, the payment confirmation message may comprise the customer ID, and the amount of payment charged to the deposit account, and information identifying the item that was purchased. In one embodiment, in order to link the payment confirmation message with a particular payment authorization message the DCPMS 102 may be configured to assign a unique payment authorization code to each payment authorization request. The unique payment authorization code may be included in each payment authorization message, and may also be included in each payment confirmation message in order that the DCPMS 102 may determine that each payment was actually authorized. In response to the payment confirmation message DCPMS 102 transfers the amount of the payment from the customer's deposit account, into a deposit account maintained for the brand owner.

In some embodiments, to deposit of cash into a customer's deposit account by a brand owner may be restricted in the sense that it can only be used for the purchase of certain products of the brand owner. For example, through data collected by the couponing service the brand owner may understand that the customer is only purchasing certain items of the brand owner and other items from a competitor. For example, consider the case with the brand owner has a soap line and a shampoo line. In this case, the brand owner may discover that a certain customer is only purchasing soap items from the brand owner, and shampoo or items from a competitor. In this case, in order to incentivize the customer to purchase from the band owners shampoo line, the brand owner made deposit a certain sum of money into the customer's deposit account solely for the use in purchasing items from said brand owners of shampoo line. To enforce the aforementioned restriction on the use of funds in the customer's deposit account originating from a brand owner, the DCPMS 102 may be configured to separately track the funds in the customers deposit account originating from a brand owner for which such a restriction exists. The aforementioned payment authorization request, and response may be modified to validate that the restricted funds are being correctly applied to the proper product.

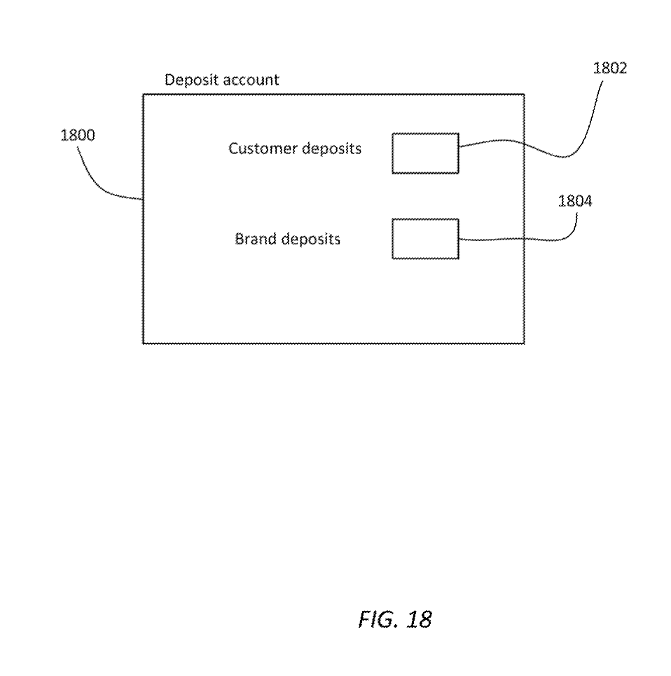

To understand how brand owner restrictions operate, consider the customer deposit account 1800 shown in FIG. 18. As will be seen, the deposit account 1800 comprises two categories of deposits, namely customer deposits 1802 brand owner deposits 1804. The customer deposits 1802 generally comprise deposits of actual cash made by a customer. These funds do not have any restrictions, and thus a customer may use these funds to purchase to any item sold by a retailer. The brand deposits 1804 may comprise those funds that were deposited into the deposit account 1800 by brand owners, typically to reward customers who are loyal. For example, loyal customers may be those customers that regularly purchase items of a particular brand owner. In one embodiment, loyal customers may be identified based on a coupon redemption statistics tracked by the couponing service disclosed herein. In some embodiments, each deposit account may be configured to be associated with only a single brand owner. In this case, all brand deposits will be from a single brand owner. However, under a more expansive model, any brand owner may make than deposits 1804 into the deposit account 1800. At the time of making each brand deposit, a brand owner may specify what products each brand deposit may be used to purchase. Thus, brands deposits may be restricted for use in connection with only certain products of a brand owner. Of course, a band owner may elect to have no restrictions placed on a brand deposit, in which case the ban deposit may be available for use in connection with any brand of the brand owner. Under the least restrictive scenario, a brand owner may have no restrictions on a brand deposit, thereby making said brand deposit available for purchase of any product, even those of a competing band owner.

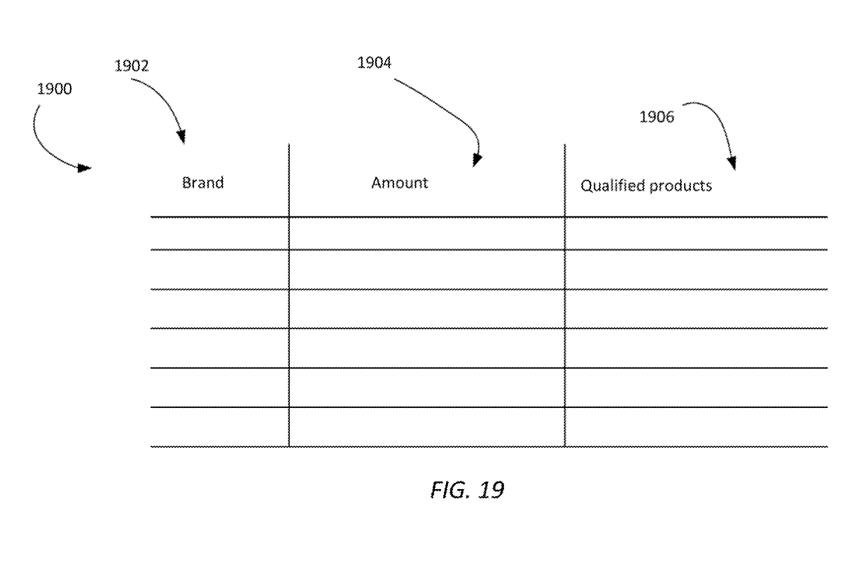

In one embodiment, to facilitate proper use of brand deposits, a data structure 1900 such as is shown in FIG. 19 may be provisioned DCPMS 102. The data structure 1900 comprises a column 1902 to track each brand owner that makes a deposit into the deposit account 1800. The actual amount of the deposit is tracked under column 1904. The column 1906 tracks a list of the particular brands for which an amount in column 1904 may be used to purchase. The data structure 1900 may be used to ensure that brand deposits are used in accordance with the restrictions placed upon them. In order to facilitate the use of restricted deposits, in one embodiment, the interface 1600 of the coupon app may be modified to show the customer deposits as well as the brand deposits in a customer's deposit account, as separate items. For the brand deposits, the restrictions may be indicated to the customer. For example, the particular brand items to which are branded products may be applied may be shown to the customer. This allows the customer to select some funds from the customer deposits, and some funds from the brand deposits when making payment for an item.

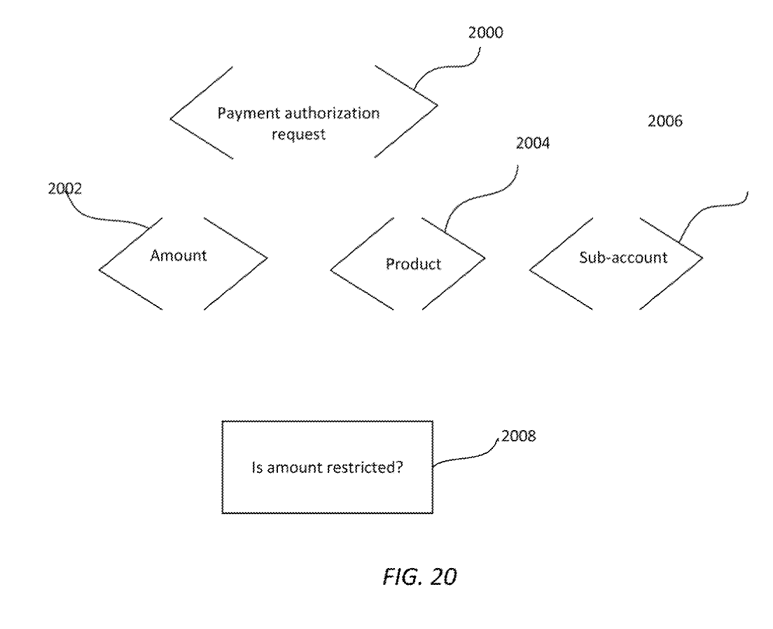

FIG. 20 shows a payment authorization request 2000 in accordance with one embodiment. The payment authorization request 2000 includes an amount 2002 to be authorized, and a product 2004 in respect of the payment of which, the funds are to be applied. Additionally, the payment authorization request 2000 also includes a sub-account 2006. This account specifies whether the amount is to be drawn against the customer deposits 1802, or the brand deposits 1804. In the case of brand deposits, the particular brand deposit is identified. It is to be appreciated that, in some embodiments, the brand deposits 1804 may comprise a plurality of separate brand deposits each comprising the deposits of a particular brand owner. Thus, the deposit account 1800 may be operated in respect of a plurality of brand owners, who each periodically deposit amounts into the band deposits 1804, in order to reward loyalty, as discussed above. To ensure that brand deposits are used only in respect of the specified products, the processing of the payment authorization requests by the DCPMS 102 may be modified to include a step 2006 which checks if the amount being requested is subject to any restrictions, and then applies those restrictions.

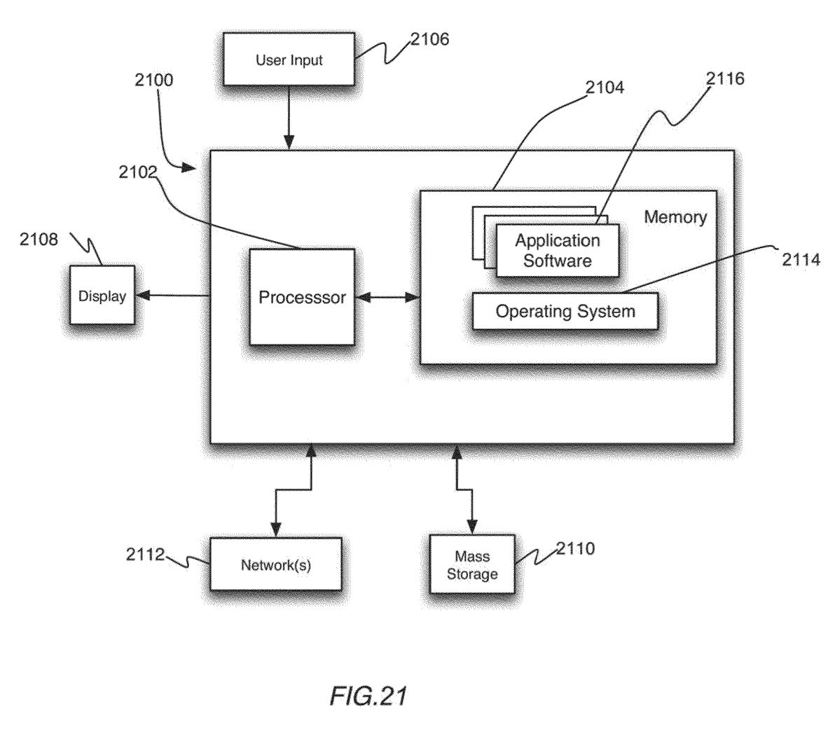

FIG. 21 shows an example of hardware 2100 that may be used to implement the DCPMS 102 in accordance with one embodiment. The hardware 2100 may include at least one processor 2102 coupled to a memory 2104. The processor 2102 may represent one or more processors (e.g., microprocessors), and the memory 2104 may represent random access memory (RAM) devices comprising a main storage of the hardware, as well as any supplemental levels of memory e.g., cache memories, non-volatile or back-up memories (e.g. programmable or flash memories), read-only memories, etc. In addition, the memory 2104 may be considered to include memory storage physically located elsewhere in the hardware, e.g. any cache memory in the processor 1302, as well as any storage capacity used as a virtual memory, e.g., as stored on a mass storage device.

The hardware also typically receives a number of inputs and outputs for communicating information externally. For interface with a user or operator, the hardware may include one or more user input output devices 1306 (e.g., a keyboard, mouse, etc.) and a display 1308. For additional storage, the hardware 1300 may also include one or more mass storage devices 2110, e.g., a Universal Serial Bus (USB) or other removable disk drive, a hard disk drive, a Direct Access Storage Device (DASD), an optical drive (e.g. a Compact Disk (CD) drive, a Digital Versatile Disk (DVD) drive, etc.) and/or a USB drive, among others. Furthermore, the hardware may include an interface with one or more networks 2112 (e.g., a local area network (LAN), a wide area network (WAN), a wireless network, and/or the Internet among others) to permit the communication of information with other computers coupled to the networks. It should be appreciated that the hardware typically includes suitable analog and/or digital interfaces between the processor 2112 and each of the components, as is well known in the art.

The hardware 2100 operates under the control of an operating system 2114, and executes application software 2116 which includes various computer software applications, components, programs, objects, modules, etc. to perform the techniques described above.

In general, the routines executed to implement the embodiments of the invention, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processors in a computer, cause the computer to perform operations necessary to execute elements involving the various aspects of the invention. Moreover, while the invention has been described in the context of fully functioning computers and computer systems, those skilled in the art will appreciate that the various embodiments of the invention are capable of being distributed as a program product in a variety of forms, and that the invention applies equally regardless of the particular type of machine or computer-readable media used to actually effect the distribution. Examples of computer-readable media include but are not limited to recordable type media such as volatile and non-volatile memory devices, USB and other removable media, hard disk drives, optical disks (e.g., Compact Disk Read-Only Memory (CD ROMS), Digital Versatile Disks, (DVDs), etc.), flash drives among others.

1. A computer-implemented method, comprising:
maintaining a deposit account for a customer on a third party server, said deposit account comprising a customer deposits component, and a brand deposits component, wherein the customer deposits component comprises cash received from the customer, and the brand deposits component comprises brand deposits received from at least one brand owner;
enabling the customer to make a payment request to at least partially pay for an item with funds from the deposit account during a check out process at a retailer;
enabling said retailer to initiate a payment authorization request to the third party server in respect of the payment request;
processing the payment authorization request by the third party server, comprising generating a payment authorization response to said retailer; wherein said payment authorization response includes an authorization message selectively generated to authorize the retailer to accept payment via the deposit account.

2. The method of claim 1, wherein a brand deposit comprises at least one of cash and loyalty points.

3. The method of claim 2, maintaining the deposit account comprises tracking restrictions imposed by a brand owner on each brand deposit.

4. The method of claim 3, wherein enabling the customer to make the payment request, comprises allowing the customer to select a combination of amounts from the customer deposits component, and at least one brand deposits component.

5. The method of claim 4, wherein processing the payment authorization request comprises verifying an availability of funds in each component of the deposit account indicated in the payment authorization request.

6. The method of claim 5, wherein processing the payment authorization request further comprises performing a check to determine that any restriction of funds in a brand deposits component placed by a brand owner is not violated.

7. The method of claim 6, wherein the brand deposits comprise payments to the customer for brand loyalty.

8. The method of claim 7, wherein the brand loyalty is tracked based on coupon redemptions associated with the customer and tracked by the third party server.

9. The method of claim 8, further comprising enabling the retailer to accept cash deposits from the customer to replenish the customer deposits component.

10. A coupon server system, comprising:
a processor, and
a memory storing instructions which when executed by the processor causes the coupon server system to perform a method comprising:
maintaining a deposit account for a customer on a third party server, said deposit account comprising a customer deposits component, and a brand deposits component, wherein the customer deposits component comprises cash received from the customer, and the brand deposits component comprises brand deposits received from at least one brand owner;
enabling the customer to make a payment request to at least partially pay for an item with funds from the deposit account during a check out process at a retailer;
enabling said retailer to initiate a payment authorization request to the third party server in respect of the payment request;
processing the payment authorization request by the third party server, comprising generating a payment authorization response to said retailer; wherein said payment authorization response includes an authorization message selectively generated to authorize the retailer to accept payment via the deposit account.

11. The system of claim 11, wherein a brand deposit comprises at least one of cash and loyalty points.

12. The system of claim 12, maintaining the deposit account comprises tracking restrictions imposed by a brand owner on each brand deposit.

13. The system of claim 13, wherein enabling the customer to make the payment request, comprises allowing the customer to select a combination of amounts from the customer deposits component, and at least one brand deposits component.

14. The system of claim 14, wherein processing the payment authorization request comprises verifying an availability of funds into each component of the deposit account indicated in the payment authorization request.

15. The system of claim 15, wherein processing the payment authorization request further comprises performing a check to determine that any restriction of funds in a brand deposits component is not violated.

16. The system of claim 16, wherein the brand deposits comprise payments to the customer for brand loyalty.

17. The system of claim 17, wherein the brand loyalty is tracked based on coupon redemptions associated with the customer and tracked by the third party server.

19. The system of claim 18, wherein the method further comprises enabling the retailer to accept cash deposits from the customer to replenish the customer deposits component.
